(19) United States
(12) Patent Application Publication
(10) Pub. No.: US 2024/0004933 A1
(43) Pub. Date: Jan. 4, 2024

(54) MINHASH SIGNATURES AS VERTICES FOR FUZZY STRING MATCH ON GRAPH

(71) Applicant: TigerGraph, Inc., Redwood City, CA (US)

(72) Inventors: Xinyu Chang, Menlo Park, CA (US); Yiming Pan, Foster City, CA (US); Thong Nguyen, Seattle, WA (US)

(21) Appl. No.: 17/852,901

(22) Filed: Jun. 29, 2022

(51) Int. Cl. G06F 16/903; G06F 16/901

(52) U.S. Cl. CPC G06F 16/90344; G06F 16/9024; G06F 16/9014

(57) ABSTRACT

Utilizing a MinHash approach during a graph loading process, vertices with similar string property values can be indirectly connected through common intermediary vertices whose identifications (IDs) are the MinHash signature values. A method for fuzzy match on a graph comprises constructing a graph using a hashing technique, determining a similarity of hash signatures of at least two properties on the graph, and using the similarity in an application. The hashing technique may be MinHash, for example. Determining the similarity may comprise using Jaccard similarity or Levenshtein distance, for example. The application may be entity resolution or text search, for example.

### BACKGROUND

The dominant model for organizing and storing data in a database has been a relational model. The relational model organizes data into one or more tables (or “relations”) of columns and rows. A more recent database model is a graph model. Compared with the relational model, the graph model is often faster for associative data sets and is a powerful tool for graph-like queries, such as computing the shortest path between two nodes in the graph. Other graph-like queries, such as diameter computations or community detection of a graph, can be performed over a graph database in a natural way.

A graph database comprises vertices (also referred to as nodes), edges, and properties (also referred to as attributes). Vertices represent data, edges represent relationships between vertices, and properties are information regarding the vertices.

In a graph database, string fuzzy match operations (e.g., approximate string matching) such as “given an input string, search vertices with string type property value that is similar to the input string” or “find a target vertex set that has a similar string property with the source vertex” are difficult to perform with a plain graph format. This is because the primary identifications (IDs) of vertices are directly loaded from the data source. Vertices created from the string values, being used as an intermediary node introducing connections to the entities who share the same value, can only serve the purpose of exact match.

It is with respect to these and other considerations that the various aspects and embodiments of the present disclosure are presented.

### SUMMARY

According to some embodiments, by utilizing a MinHash approach during the graph loading process, vertices with similar string property values can be indirectly connected through common intermediary vertices whose IDs are the MinHash signature values.

In an embodiment, a method for fuzzy match on a graph having at least one vertex and at least one edge, each vertex defining at least one property, is provided. The method comprises constructing a graph using a hashing technique, determining a similarity of hash signatures of at least two properties on the graph, and using the similarity in an application.

In an embodiment, a method for fuzzy match on a graph having at least one vertex and at least one edge, each vertex defining at least one property, is provided. The method comprises constructing a graph using a hashing technique and a loading job, performing a fuzzy match between vertices of the graph, and using results of the fuzzy match in an application.

In an embodiment, a system is provided that comprises a schema definition engine configured to define a graph with hash signature vertices, a loading logic engine configured to define a loading job to construct the graph, a data ingestion engine configured to construct the graph using the loading job, and a fuzzy matching engine configured to perform fuzzy matching on the graph.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an exemplary diagram illustrating an embodiment of a graph model;

FIG. 2 is an illustration of an exemplary system for fuzzy string matching using a graph model;

FIG. 3 is an exemplary diagram illustrating an embodiment of a system for fuzzy string matching using a graph model;

FIG. 4 is an operational flow of an implementation of a method of fuzzy string matching;

FIG. 5 is an operational flow of another implementation of a method of fuzzy string matching; and

FIG. 6 is a diagram that shows the edges between the entity that owns the string property connected with the MinHash signature of the string values; and

FIG. 7 shows an exemplary computing environment in which example embodiments and aspects may be implemented.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

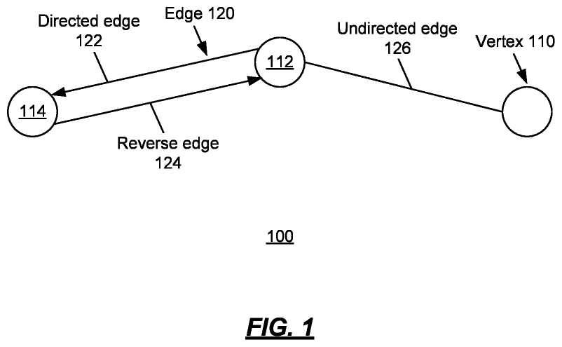

FIG. 1 is an exemplary diagram illustrating an embodiment of a graph model 100. The graph model 100 can include one or more vertices 110 and/or one or more edges 120. A vertex 110 can have one or more properties. The value of each property can identify and/or characterize the vertex 110. For each property, the value can be uniform and/or different among the vertices 110.

An exemplary property can include a primary identification (ID) to uniquely identify the vertex 110. Values of the property primary ID of vertices 110 can identify the vertices 110, respectively. An edge 120 can represent a relation between a pair of vertices 110. The edge 120 can be directed and/or undirected. As shown in FIG. 1, a directed edge 122 can indicate a direction between a pair of vertices 110, starting from a from_vertex 112 and ending at a to_vertex 114. For example, the directed edge 122 can be described by “(from_vertex 112, to_vertex 114).”

A reverse edge 124 of the edge 120 can start from the to_vertex 114 and end at the from_vertex 112. An undirected edge 126 can indicate a relation between the pair of vertices 110, without necessarily distinguishing the vertex 110 for starting and/or ending the undirected edge 126.

A vertex type can include a data category to which one or more vertices 110 belong. If one or more selected vertices 110 each represent data of a person, for example, the selected vertices 110 can belong to a person vertex type. A property of the vertex type can include the property of each vertex 110 of the vertex type.

An edge type can describe a data category to which one or more edges 120 belong. If one or more selected edges 120 each represent data of person (that is, a vertex 110 representing person) recommending movie (that is, a vertex 110 representing movie), for example, the selected edges 120 can belong to a recommendation edge type. A property of the edge_type can include the property of each edge 120 of the edge type.

The graph model 100 can include vertices 110 associated with one or more vertex types and edges 120 associated with one or more edge types. For example, the graph model 100 representing person recommending movie can be created based on a person vertex type, a movie vertex type, and/or a recommendation edge type connecting from the person vertex type to the movie vertex type.

MinHash is a well known technique for evaluating string similarities. MinHash can reduce each string into fixed dimensions which is a set of MinHash signatures. By calculating the Jaccard Similarity of the MinHash signature sets of different strings, a string similarity can be obtained.

Determining a MinHash signature comprises the following operations. Calculate the k-shingle of a given size k of a string. The k-shingle of a string is all possible consecutive substrings of length k. For example, the k-shingle with a k value of 4 of the string “James Smith” is {“Jame”, “ames”, “mes”, “es S”, “s Sm”, “ Smit”, “mith”}.

Then hash each substring into I integer hash codes with I different hash functions. Continuing with the example above and setting I equal to 4, Table 1 with example hashcodes (e.g., hashcode 1, hashcode 2, hashcode 3, and hashcode 4) is obtained:

TABLE 1

| substring | hashcode1 | hashcode2 | hashcode3 | hashcode4 |
|---|---|---|---|---|
| “Jame” | 322 | 717 | 21 | 36 |
| “ames” | 45 | 3128 | 325 | 213 |
| “mes” | 23 | 412 | 5443 | 3253 |
| “es S” | 3226 | 23481 | 3425 | 229 |
| “s Sm” | 3219 | 321 | 1318 | 1328 |
| “Smit” | 1183 | 3198 | 3178 | 1628 |
| “mith” | 318 | 8278 | 3618 | 1982 |

As can be seen from Table 1, the minimum hashcode value for each hashcode of the example (e.g., hashcode 1, hashcode 2, hashcode 3, and hashcode 4) is 23, 321, 21 and 36, respectively. Therefore, in this example, the MinHash signature of string “James Smith” is {23, 321, 21, 36}.

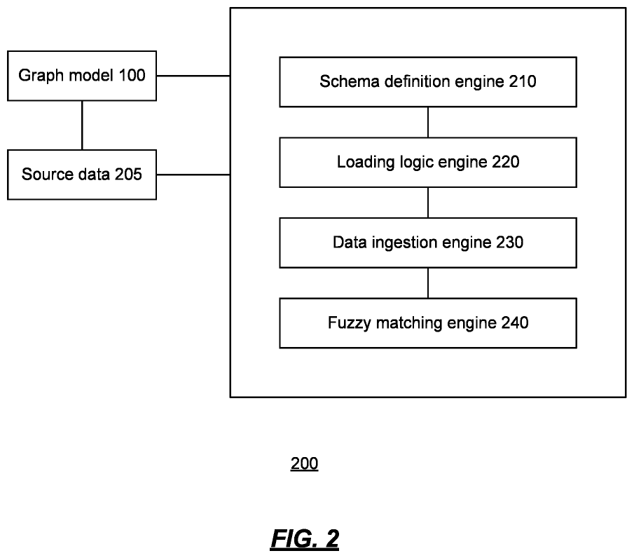

FIG. 2 is an illustration of an exemplary system 200 for fuzzy string matching using a graph model such as the graph model 100 of FIG. 1. The system 200 includes a variety of components including a schema definition engine 210, a loading logic engine 220, a data ingestion engine 230, and a fuzzy matching engine 240. More or fewer components may be supported. Source data 205 is also provided.

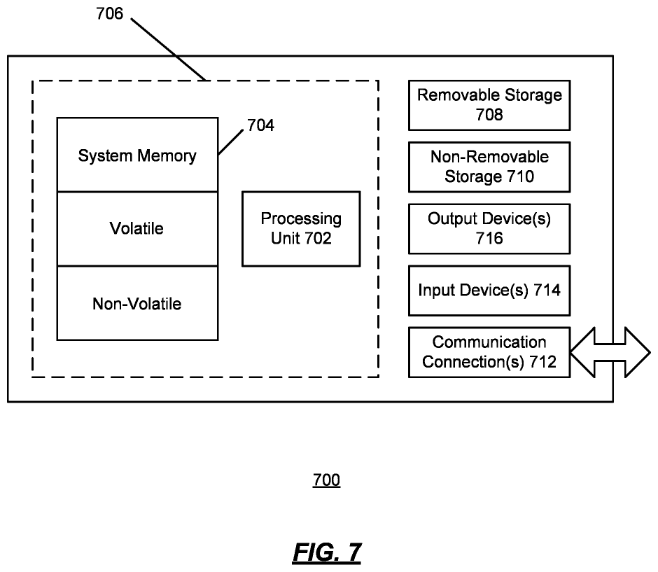

The system 200 may be implemented using a variety of computing devices such as desktop computers, laptop computers, tablets, smartphones, set top boxes, vehicle navigation systems, and video game consoles. Other types of computing devices may be supported. A suitable computing device is illustrated in FIG. 7 as the computing device 700. Some or all of the components of the system 200 may be implemented together or separately by a general purpose computing device such as the computing device 700 described with respect to FIG. 7. In addition, some or all of the components may be implemented together or separately by a cloud-based computing environment.

The schema definition engine 210 defines the intermediary MinHash signature vertices in the schema.

The loading logic engine 220 defines the loading job to convert the string value (e.g., from the source data 220) to k MinHash code value. Additionally, the loading logic engine 220 builds the edge between the vertex that owns the string value and the MinHash signature vertex.

The data ingestion engine 230 performs the loading based on the loading logic defined by the loading logic engine 220. Additionally, the data ingestion engine 230 converts the data in tabular format into graph format.

The fuzzy matching engine 240 performs fuzzy matching on the graph, as described further herein. The fuzzy matching finds the vertices with similar string values by traversing the MinHash signature vertices.

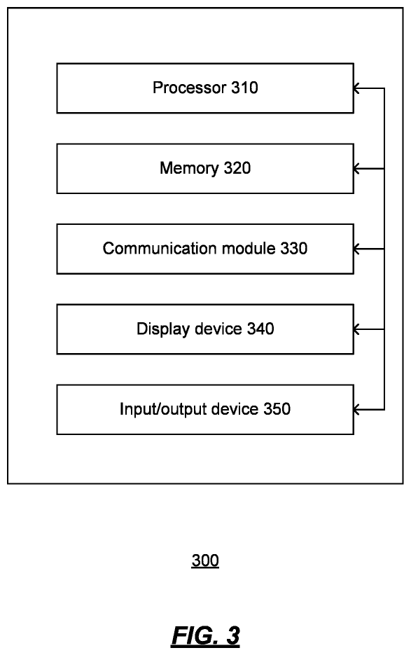

FIG. 3 is an exemplary diagram illustrating an embodiment of a system 300 for fuzzy string matching using a graph model such as the graph model 100 of FIG. 1. The system 300 can include a processor 310. The processor 310 can include one or more general-purpose microprocessors (for example, single or multi-core processors), application-specific integrated circuits, application-specific instruction-set processors, graphics processing units, physics processing units, digital signal processing units, coprocessors, network processing units, encryption processing units, and the like.

As shown in FIG. 3, the system 300 can include one or more additional hardware components as desired. Exemplary additional hardware components include, but are not limited to, a memory 320 (alternatively referred to herein as a non-transitory computer readable medium). Exemplary memory 320 can include, for example, random access memory (RAM), static RAM, dynamic RAM, read-only memory (ROM), programmable ROM, erasable programmable ROM, electrically erasable programmable ROM, flash memory, secure digital (SD) card, and/or the like. Instructions for implementing the system 300 can be stored on the memory 320 to be executed by the processor 310.

Additionally and/or alternatively, the system 300 can include a communication module 330. The communication module 330 can include any conventional hardware and software that operates to exchange data and/or instruction between the system 300 and another computer system (not shown) using any wired and/or wireless communication methods. For example, the system 300 can receive data in tabular format from another computer system via the communication module 330. Exemplary communication methods include, for example, radio, Wireless Fidelity (Wi-Fi), cellular, satellite, broadcasting, or a combination thereof.

Additionally and/or alternatively, the system 300 can include a display device 340. The display device 340 can include any device that operates to present programming instructions for operating the system 300, and/or present data in the graph model 100. Additionally and/or alternatively, the system 300 can include one or more input/output devices 350 (for example, buttons, a keyboard, a keypad, a trackball, etc.), as desired.

The processor 310, the memory 320, the communication module 330, the display device 340, and/or the input/output device 350 can be configured to communicate, for example, using hardware connectors and buses and/or in a wireless manner.

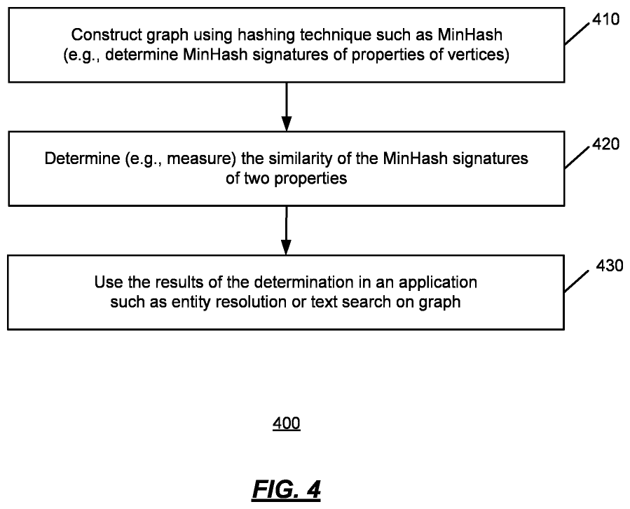

FIG. 4 is an operational flow of an implementation of a method 400 of fuzzy string matching. In some implementations, the method 400 can be implemented by the system 300.

At 410, a graph (also referred to as a graph model) is constructed with a hashing technique. In some implementations, the graph may be stored in a storage or memory, such as in a graph store. In an implementation, the MinHash signatures of properties of vertices are determined. Each vertex will have an associated MinHash signature of property. Thus, for example, the MinHash signatures of two properties, property 1 and property 2, of two vertices, vertex 1 and vertex 2 respectively, are determined. Each signature may be stored on a graph as a respective vertex. If the vertices have similar properties, then they should share some common MinHash signatures. Whichever vertices share the same (or similar) MinHash signature means they have something in common (e.g., similar properties, such as similar strings). Example properties of a vertex may include a person's name, a street name, a city name, a title, etc., depending on the implementation. These examples of properties are not intended to be limiting and any string or value may be a property of a vertex depending on the implementation.

At 420, the similarity of the MinHash signatures of the two properties is determined (e.g., measured). Any known technique for determining similarity may be used, such as Jaccard similarity or Levenshtein distance, for example. Thus, for example, to measure the similarity between the property of vertex 1 and the property of vertex 2, calculate the cosine similarity of their MinHash signature set or measure the string distance through the graph value propagation (using Levenshtein distance), depending on the implementation.

At 430, an application may be performed using the results of the similarity determination of 420. Applications include, but are not limited to, entity resolution and text search.

Although embodiments described herein use MinHash for signatures and similarity determination, this is not intended to be limiting, and any hashing technique may be used to determine the similarity of the code of two properties as long as the hashing technique provides similar string values for entities that have the same (or similar) hash code.

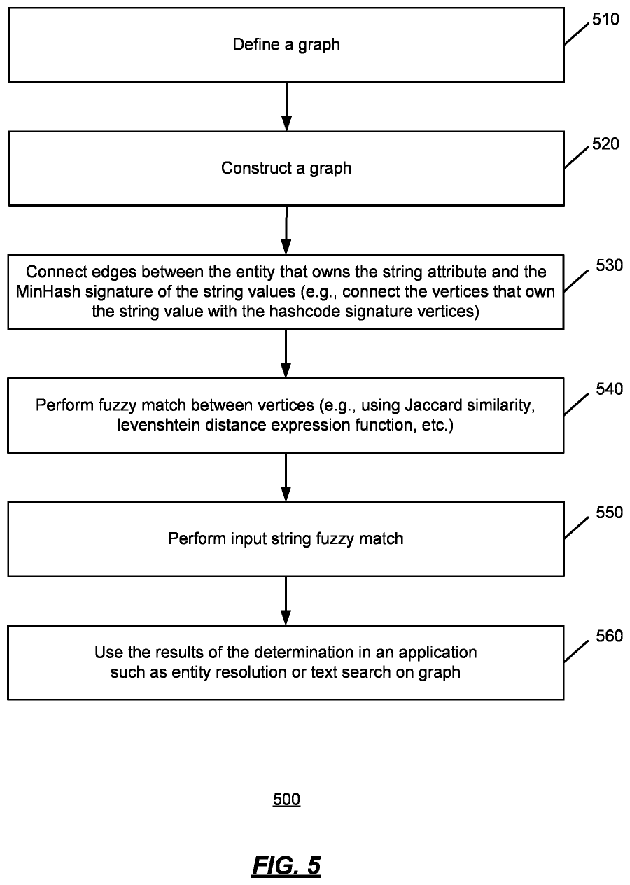

FIG. 5 is an operational flow of another implementation of a method 500 of fuzzy string matching. In some implementations, the method 500 can be implemented by the system 300.

At 510, a graph is defined. In an implementation, in the graph schema, the vertex type for MinHash signature is defined, and the edge type between the entity that owns the string property and the MinHash signature vertex is defined.

At 520, a graph is constructed. In the loading job, the strings to be matched are converted into k MinHash signatures values. The number k is a configurable number of hash functions to be used in the MinHash process. In an implementation, a TokenBank function is used, wherein the input to the TokenBank function is the string value for the fuzzy matching, and the value of k and l. The output of the TokenBank function is the MinHash Signature delimited by “|”. With the output, the flatten function of the loading job is used to load the split string into a temp_table.

Table 2 shows an example of loading code.

TABLE 2

| Line | Instructions |
|---|---|
| 1 | LOAD f0 TO TEMP_TABLE t4(original, |
| | minhashSignature,) VALUES($8, |
| | FLATTEN (minHash($8,“3”,“5”,“3”), “\|”, 1)) |
| | USING header = “true”, separator = |
| | “,”; |
| 2 | LOAD TEMP_TABLE t4 TO EDGE Song_TO_artist |
| | VALUES($“original”, |
| | $“minhashSignature”, $“original”); |

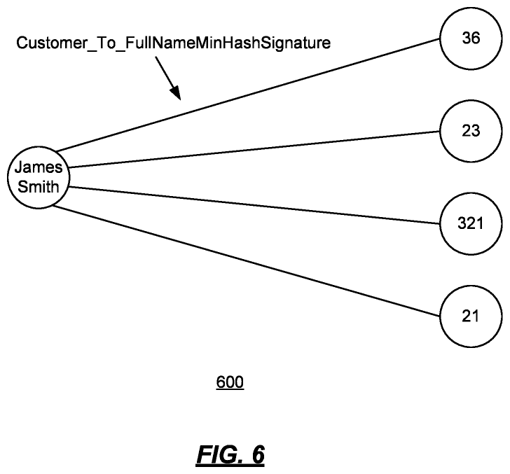

At 530, by loading from the temp_table, the edges between the entity that has the string property and the MinHash signatures of the string value are connected. Continuing with the example provided above with respect to “James Smith”, FIG. 6 is a diagram that shows the edges between the entity that owns the string property (e.g., James Smith) connected with the MinHash signature of the string values 36, 23, 321, and 21.

Thus, in some implementations in the loading job, the vertices that own the string value are connected to the k hashcode signature vertices.

At 540, to perform the fuzzy match between vertices, either Jaccard similarity is applied or the Levenshtein distance expression function is used, depending on the implementation. The Jaccard similarity approach calculates the topological similarity based on the number of common MinHash signature vertices between the vertices to be matched. The Jaccard similarity will be between 0 and 1. For strings, in some implementations, Levenshtein distance may be used.

Table 3 shows an example Jaccard similarity algorithm. It is noted that only the related vertex/edge types need to be passed to the Jaccard similarity algorithm to find the top k vertexes with the most similar string values.

TABLE 3

| Line | Instructions |
|---|---|
| 1 | CREATE QUERY tg_jaccard_nbor_ss (VERTEX source, STRING e_type, STRING |
| | rev_e_type, |
| 2 | INT top_k = 100, BOOL print_accum = TRUE, STRING similarity_edge_type = “”, |
| | STRING file_path = “”) SYNTAX V1 { |
| 3 | |
| 4 | /* |
| 5 | Calculates the Jaccard Similarity between a given vertex and every other vertex. |
| 6 | Jaccard similarity = intersection_size / (size_A + size_B − intersection_size) |
| 7 | Parameters: |
| 8 | source: start vertex top_k: #top scores to report |
| 9 | e_type: directed edge types to traverse print_accum: print JSON output |
| 10 | rev_e_type: reverse edge types to traverse file_path: file to write CSV output to |
| 11 | similarity_edge_type: edge type for storing vertex-vertex similarity scores |
| 12 | |
| 13 | This query current supports only a single edge type (not a set of types) - 8/13/20 |
| 14 | */ |
| 15 | |
| 16 | SumAccum<INT> @sum_intersection_size, @@sum_set_size_A, |
| | @sum_set_size_B; |
| 17 | SumAccum<FLOAT> @sum_similarity; |
| 18 | FILE f (file_path); |
| 19 | |
| 20 | Start (ANY) = {source}; |
| 21 | Start = SELECT s |
| 22 | FROM Start:s |
| 23 | ACCUM @@sum_set_size_A += s.outdegree(e_type); |
| 24 | |
| 25 | Subjects = SELECT t |
| 26 | FROM Start:s−(e_type:e)−:t; |
| 27 | |
| 28 | Others = SELECT t |
| 29 | FROM Subjects:s −(rev_e_type:e)− :t |
| 30 | WHERE t != source |
| 31 | ACCUM |
| 32 | t.@sum_intersection_size += 1, |
| 33 | t.@sum_set_size_B = t.outdegree(e_type) |
| 34 | POST-ACCUM |
| 35 | |
| | t.@sum_similarity = |
| | t.@sum_intersection_size*1.0/(@@sum_set_size_A + |
| 36 | t.@sum_set_size_B − t.@sum_intersection_size) |
| 37 | ORDER BY t.@sum_similarity DESC |
| 38 | LIMIT top_k; |
| 39 | |
| 40 | IF file_path != “” THEN |
| 41 | f.printIn(“Vertex1”, “Vertex2”, “Similarity”); |
| 42 | END; |
| 43 | |
| 44 | Others = SELECT s |
| 45 | FROM Others:s |
| 46 | POST-ACCUM |
| 47 | IF similarity_edge_type != “” THEN |
| | INSERT INTO EDGE similarity_edge_type VALUES (source, s, |
| 48 | s.@sum_similarity) |
| 49 | END, |
| 50 | IF file_path != “” THEN |
| 51 | f.printIn(source, s, s.@sum_similarity) |
| 52 | END; |
| 53 | |
| 54 | IF print_accum THEN |
| 55 | PRINT Others[Others.@sum_similarity]; |
| 56 | END; |
| | } |

Table 4 shows an example string distance GSQL code.

TABLE 4

| Line | Instructions |
|---|---|
| 1 | WHEN “Account_TO_minhash” THEN |
| 2 | FOREACH tup IN s.@Account_minhash_list DO |
| 3 | IF getvid(tup.ver) < getvid(t) THEN |
| 4 | t.@Account_map +=(tup.ver>minhash_weight*jaroWinklerDistance(e.str,tup.str)) |
| 5 | END |
| 6 | END |

At 550, to do input string fuzzy match, the input string is converted into k MinHash signature values M, and a set of MinHash signature vertices V with IDs in M are searched from the database. Then the same measurement as in 530 is performed over V.

Table 5 shows an example of code for a search string value with an input string.

TABLE 5

| Line | Instructions |
|---|---|
| 1 | CREATE QUERY search(STRING value, STRING feat_v_type, STRING v_type) FOR |
| | GRAPH |
| 2 | Singtel_Poc { |
| 3 | /* Write query logic here */ |
| 4 | ListAccum<STRING> @@hash_ids; |
| 5 | INT hash_count = 3; |
| 6 | STRING concatinated_hash_codes = minHash(value, hash_count, 3, 3); |
| 7 | FOREACH i IN RANGE[0, hash_count − 1] DO |
| 8 | @@hash_ids += getlth(concatinated_hash_codes, i); |
| 9 | END; |
| 10 | S2 = to_vertex_set(@@hash_ids, feat_v_type); |
| 11 | S2 = SELECT t |
| 12 | FROM S2:s − ( ) − v_type:t; |
| 13 | PRINT S2; |
| 14 | } |

Applications may be performed at 560 in accordance with the methods and techniques described herein. Applications include entity resolution and text search on graph, for example.

In the graph-based entity resolution use case, the entity resolution problem is a multi-dimensional matching problem. Fuzzy match is required for some of the dimensions such as full names or address or property when there was typo or different way of writing an address or a property. In this case, entities to be deduplicated are connected through the same MinHash signatures if they have the similar string values. The MinHash technique connects entities even when there is a way to conduct an exact match.

Regarding text search, a search string may be encoded into multiple signatures. And using the signatures, vertices may be determined that have values similar to the search string.

It is contemplated that features described herein may be stored natively in the graph database in the form of vertices and edges, so the data structure is automatically partitioned and stored distributedly. Moreover, the search is done through graph traversal, which means different algorithms or techniques to evaluate the string distance may be used. Furthermore, the searches are automatically parallelized.

FIG. 7 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as RAM), non-volatile (such as ROM, flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an embodiment, a method for fuzzy match on a graph having at least one vertex and at least one edge, each vertex defining at least one property, is provided. The method comprises constructing a graph using a hashing technique, determining a similarity of hash signatures of at least two properties on the graph, and using the similarity in an application.

Embodiments may include some or all of the following features. Constructing the graph comprises determining the hash signatures of the at least two properties on the graph and storing the hash signatures on the graph as vertices. The method further comprises determining that the vertices have similar properties responsive to determining that the hash signatures of the at least two properties are similar. The hashing technique is MinHash. Determining the similarity comprises using Jaccard similarity. Determining the similarity comprises using Levenshtein distance. The application is entity resolution. The application is text search. The method further comprises storing the graph in a storage.

In an embodiment, a method for fuzzy match on a graph having at least one vertex and at least one edge, each vertex defining at least one property, is provided. The method comprises constructing a graph using a hashing technique and a loading job, performing a fuzzy match between vertices of the graph, and using results of the fuzzy match in an application.

Embodiments may include some or all of the following features. The method further comprises defining the graph prior to constructing the graph. Constructing the graph comprises converting strings to be matched into a plurality of hash signature values. Constructing the graph comprises connecting edges of the entity that has a string property with hash signatures of the string value. The hashing technique is MinHash. Performing the fuzzy match comprises using Jaccard similarity. Performing the fuzzy match comprises using Levenshtein distance. The application is entity resolution. The application is text search.

In an embodiment, a system is provided that comprises a schema definition engine configured to define a graph with hash signature vertices, a loading logic engine configured to define a loading job to construct the graph, a data ingestion engine configured to construct the graph using the loading job, and a fuzzy matching engine configured to perform fuzzy matching on the graph.

Embodiments may include some or all of the following features. The hash signature vertices are generated using MinHash, and the fuzzy matching uses one of Jaccard similarity or Levenshtein distance.

As used herein, the singular form “a,” “an,” and “the” include plural references unless the context clearly dictates otherwise. As used herein, the terms “can,” “may,” “optionally,” “can optionally,” and “may optionally” are used interchangeably and are meant to include cases in which the condition occurs as well as cases in which the condition does not occur.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for fuzzy match on a graph having at least one vertex and at least one edge, each vertex defining at least one property, the method comprising:
constructing a graph using a hashing technique;
determining a similarity of hash signatures of at least two properties on the graph; and
using the similarity in an application.

2. The method of claim 1, wherein constructing the graph comprises determining the hash signatures of the at least two properties on the graph and storing the hash signatures on the graph as vertices.

3. The method of claim 2, further comprising determining that the vertices have similar properties responsive to determining that the hash signatures of the at least two properties are similar.

4. The method of claim 1, wherein the hashing technique is MinHash.

5. The method of claim 1, wherein determining the similarity comprises using Jaccard similarity.

6. The method of claim 1, wherein determining the similarity comprises using Levenshtein distance.

7. The method of claim 1, wherein the application is entity resolution.

8. The method of claim 1, wherein the application is text search.

9. The method of claim 1, further comprising storing the graph in a storage.

10. A method for fuzzy match on a graph having at least one vertex and at least one edge, each vertex defining at least one property, the method comprising:
constructing a graph using a hashing technique and a loading job;
performing a fuzzy match between vertices of the graph; and
using results of the fuzzy match in an application.

11. The method of claim 10, further comprising defining the graph prior to constructing the graph.

12. The method of claim 10, wherein constructing the graph comprises converting strings to be matched into a plurality of hash signature values.

13. The method of claim 10, wherein constructing the graph comprises connecting edges of the entity that has a string property with hash signatures of the string value.

14. The method of claim 10, wherein the hashing technique is MinHash.

15. The method of claim 10, wherein performing the fuzzy match comprises using Jaccard similarity.

16. The method of claim 10, wherein performing the fuzzy match comprises using Levenshtein distance.

17. The method of claim 10, wherein the application is entity resolution.

18. The method of claim 10, wherein the application is text search.

19. A system comprising:
a schema definition engine configured to define a graph with hash signature vertices;
a loading logic engine configured to define a loading job to construct the graph;
a data ingestion engine configured to construct the graph using the loading job; and
a fuzzy matching engine configured to perform fuzzy matching on the graph.

20. The system of claim 19, wherein the hash signature vertices are generated using MinHash, and the fuzzy matching uses one of Jaccard similarity or Levenshtein distance.
